(19) United States
(12) Patent Application Publication
(10) Pub. No.: US 2004/0153709 A1
(43) Pub. Date: Aug. 5, 2004

(54) Method and apparatus for providing transparent fault tolerance within an application server environment

(76) Inventor: Noel Morgen Burton-Krahn, Victoria (CA)

Correspondence Address: Noel Burton-Krahn, 919 Dunsmuir Road, Victoria, BC, V9A 5C4, CA

(21) Appl. No.: 10/611,930

(22) Filed: Jul. 3, 2003

Related U.S. Application Data
(60) Provisional application No. 60/393,630, filed on Jul. 3, 2002.

(51) Int. Cl. H04L 1/22

(52) U.S. Cl. 714/4

(57) ABSTRACT

Disclosed is an apparatus for providing transparent fault protection for redundant server systems comprising a plurality of servers connected to a plurality of clients over a network. One or more servers are configured in a master and back-up configurations. Each server operates independently from the other and each server is connected to the network using an identical address so that each master and back-up server receives the same client communications. Each server runs the same copy of operating system, server application system and fail over protection system programs. The invention provides for a method of transparent fail over protection between the master and the back-up servers by synchronizing the operation of the master with the back-up. Synchronization is accomplished by synchronizing the initial state of the operating system by ensuring that the respective master and back-up operating systems are using the same file systems. Synchronization of the servers also necessitates synchronization of the application states of the respective master and back-up server application programs and synchronization of the respective network connection states between the master and back-up servers and the network respectively. Once synchronization is achieved, the fail over between master and back-up servers will be transparent to the client.

### CROSS-REFERENCE TO RELATED APPLICATIONS

This application is entitled to the benefit of Provisional Patent Application 60/393,630 filed on Jul. 3, 2002.

### REFERENCE TO MICROFICHE APPENDIX

Not applicable.

### FIELD OF THE INVENTION

This invention pertains to providing fault protection for server systems and more particularly a method and apparatus for providing transparent fault tolerance within an application server environment.

### BACKGROUND OF THE INVENTION

Computer network server applications must support many simultaneous client connections at all times. They need to be scalable to many users, available at any time, and each connection must be completely reliable. These features are critical in the long term, but are usually only considered after initial development. Most server applications are developed with inexpensive components that do not support high availability or scalability. After initial development, they must be altered to deal with hardware faults and high connection loads.

Servers may become unavailable for many reasons such as hardware failure, software failure, maintenance outages, network infrastructure failure and physical damage due to unforeseen events such as fires or floods. Each failure mode has a unique duration and potential to corrupt or loose data. Adding fault tolerance to an existing system can be difficult and expensive, and may not be possible for some kinds of server applications. Many computer network server applications are developed using freely available tools like Linux™, Apache™, PHP™ and MySQL™. However, none of these applications have built-in fault tolerance.

Computer network server applications vary between web servers (HTTP), web applications (HTML), databases (eg. MySQL™ and Oracle™), streaming media (eg. RealAudio™) and teleconferencing (eg. NetMeeting™ and Roger Wilco™). Understandably, servers must be continuously available despite server failures. Since each application has a different client connection characteristic (such as duration of connection and internal state of the server), different server failure modes are encountered necessitating various strategies for fault tolerance. For example, redundant servers or server clustering provides good fault tolerance for HTTP and HTML applications. However, if the active server fails the client's connection will be broken and data can be lost. Databases are particularly vulnerable to failures because they must support many concurrent read/write transactions. Databases generally rely solely on periodic back-up. Therefore, database failure can result in lost information between the time of the last back-up and the time of failure. Commercial redundant database solutions like Oracle™ and Solid™ provide better reliability but they are expensive. Many applications are made with freely available databases like MySQL™ and PostgreSQL™ that have excellent performance, but no built-in fault tolerance. Server redundancy does not necessarily increase the reliability of streaming media over the Internet. For example, a broken connection during a movie may result in having to restart the movie from the beginning. Alternatively, the server may have to support an ability to restart a broken data stream resulting in additional costs to the user.

One example of a known art device for fault tolerance is described in U.S. Pat. No. 6,097,882 “Method and apparatus of improving network performance and network availability in a client-server network by transparently replicating a network service” issued to Mogul on Aug. 1, 2000. Mogul describes a server cluster where a “replicator” transparently distributes requests from clients to servers. However, there is no effort to preserve a connection if the server fails or to transfer server state from a failed server. Another example of a known art fault tolerance device is described in U.S. Pat. No. 6,256,641 “Client transparency system and method therefore” issued to Kasi on Jul. 3, 2001. Kasi teaches a programming scheme which adds a middle component between a client and a server. The middle component will retry a request if the server fails, without the client knowing. This only works for transaction-based applications. The state from the failed server is not preserved.

It is apparent that the known art methods of providing higher server availability such as server clusters, periodic back-up and redundant hardware have limitations. They allow users to reconnect to a new server if one fails but connections and state at the failed sever will be lost. These solutions often rely on client connections being short and repeatable. They are not suitable for a real-time teleconferencing, gaming applications or databases because redundant database servers must maintain a consistent state. They can be very expensive to implement requiring additional programming labor and hardware.

There is still no general way to provide inexpensive and transparent failover for off-the-shelf servers. Therefore, there is still a requirement to provide a method and apparatus that permits any existing server to fail over transparently to a back-up server without breaking client connections.

### SUMMARY OF THE INVENTION

The present invention provides a redundant server system for providing transparent fault tolerance within an application server environment comprising a network of computers. The preferred embodiment of the present invention comprises one server designated as a master server for storing and operating a first operating system program and a first server application program. The master server is connected to a computer network and has a network address. The invention also includes a second server designated as a back-up server. The back-up server stores and operates a second operating system program and a second server application program. The second operating system program and second server application program are identical to the first operating system program and the first server application program. The back-up server is also operatively connected to the same computer network.

The master server is operatively connected to the back-up server and the two servers are in continuous communication with each other. One novel feature of my invention is that the operation of the master server and back-up server are synchronized. Included are means for monitoring synchronicity between the master server and the back-up server and means for detecting non-synchronicity between the two servers. In the failure modes contemplated by my invention, the master server may fail to operate resulting in a non-synchronicity between it and the back-up. In this case, the master server will terminate its operation and all functions of the master server will be transferred to the back-up server without the client knowing the transfer has taken place and without any loss of data, in other words, transparently. The other failure mode of the system is when the back-up server fails to operate in a synchronized manner with the master. In this scenario, the back-up server will terminate and all functions will remain with the operating master. Within each server there is embedded automatic fail-over protection. The fail over protection will, upon a detection of non-synchronicity between the two servers, invoke a transfer of server operations from the failed server to the non-failed server.

My invention also discloses a method for providing transparent fault tolerance within an application server environment comprising a network of computers. The method comprises the steps of:

a. providing a first server for storing and operating a first operating system program and a first server application program;

b. providing a second server for storing and operating a second operating system program and a second server application program;

c. placing said first server in communication with said second server;

d. selecting from the first server and the second server a master server and a back-up server;

e. synchronizing the operation of the master server and the back-up server;

f. providing from the network an identical client data stream input simultaneously to the master server and the back-up server wherein:

i. the master server and back-up server have the same network address

ii. the master server and back-up server simultaneously process said identical client data stream; and wherein,

iii. the master server and the back-up server simultaneously produce a respective first and second output data streams; and wherein,

iv. said first and said second output data streams are identical if the master server and the back-up server are operating correctly;

g. comparing said first output data stream with said second output data stream for divergence from identicality of the first output data stream from the second output data stream;

h. detecting no divergence from identicality of the first output data stream from the second output data stream;

In the event that the invention detects non-synchronicity, the invention will execute the following steps:

a. receive an indication of divergence from identicality of the first output data stream from the second output data stream;

b. initiate fail over protection wherein the backup assumes the duty of the master without breaking any network connections.

### OBJECTS AND ADVANTAGES OF THE INVENTION

My invention has as its objects and advantages the following:

to provide transparent fail over for commercial servers which do not have inherent fail over protection;

to protect against faults that cause a host to become unresponsive such as hardware failures, network failures, power failures, or natural disasters;

making a server highly available even though it runs on unreliable hardware; and,

replicate the application state of a master server on a back-up server by running an identical copy of the server application program on the back-up server and feeding the back-up server the same input as the master server.

The above and additional advantages of the present invention will become apparent to those skilled in the art from a reading of the following detailed description when taken in conjunction with the accompanying drawings.

### BRIEF DESCRIPTION OF THE DRAWINGS

FIG. 1 shows a client connected to a single non-replicated server

FIG. 2 shows a client connected to replicated servers embodying the present invention.

FIG. 3 shows the relationship between the present invention and the other operating programs within the servers.

FIG. 4 schematically portrays the synchronizing of system calls.

FIG. 5 shows a process for the interception of system calls.

FIG. 6. shows schematically how the network connection states between the Master and Back-up servers are synchronized.

FIG. 7 shows schematically the synchronization of TCP packets from client to servers.

FIG. 8 shows schematically the synchronization of TCP packets from servers to client.

### DETAILED DESCRIPTION OF THE INVENTION

Definitions

The following terms are defined for additional clarity.

Client—is a program that connects to a server.

Server—a server is a collection of processes on a single device that accept and process connections from clients.

Master—the primary server responsible for handing a client connection.

Back-up—an identical server to the Master that can take over the client connection if the Master fails.

Failover—The ability for a client connection to be relocated from Master to Back-up without interruption or loss of information. Failover should be transparent to clients. The client's connection should not be broken or need to be manually restarted. The difficult part of transparent fail over is transferring the state from the failed Master to the Back-up.

Application State—As the client and server communicate, the Master server application program changes state. The Master server application program may advance a file pointer, update files on disk, or change its internal memory state. This is known as the Application State. The present invention runs the Master and the Back-up servers in such a way as to synchronize Application State efficiently.

Network Connection State—The operating system uses a network protocol to connect the Master with the Client. This network protocol uses a set of state variables. For example, the TCP protocol includes sequence numbers (SEQ) acknowledgements (ACK), and timers for timeouts and retransmits. This set of state variables is known as the Network Connection State. The Back-up must replicate the Network Connection State for transparent fail over.

System Call—Application programs interact with operating systems by System Calls. A System Call occurs when an application program invokes a function that is implemented by its operating system, for example, open or read a file or get the current time.

System State—The state of the operating system in which a server application program runs.

That includes the current time, the available files and process identifications etc..

### DESCRIPTION OF THE PREFERRED EMBODIMENT

The preferred embodiment of the present invention provides a method and an apparatus for providing fault tolerance through transparent fail over protection to existing off-the-shelf servers with little or no modification or rewriting of the existing server software. For ease of reference, throughout this disclosure, I will be making reference to my invention as HOTSWAP. HOTSWAP applies to web servers, mail servers, teleconferencing servers and any server that supports a process that accepts connections from a client and includes a program that initiates connections to a server.

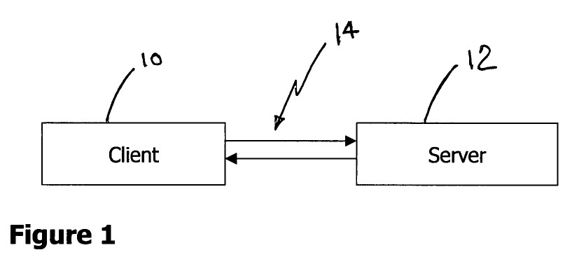

Referring to FIG. 1 there is shown in schematic form a single client (10) connected to a single server (12) through the Internet. (14) in a non-redundant fashion. In this configuration, failure of the single server will result in failure of the client connection and loss of data.

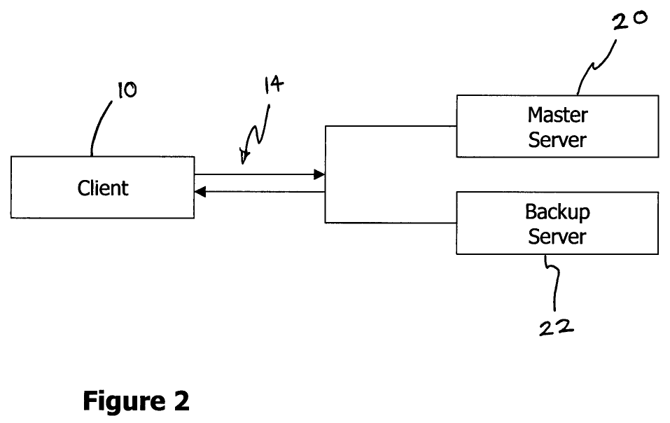

HOTSWAP also provides for a method for controlling two different servers that cooperate to run two independent copies of a server application program in sync. One of these computers is called the “Master” and the other is the “Back-up”. FIG. 2 a typical redundant server system in which HOTSWAP would be used. The client (10) transmits data packets over the Internet (14) to be received simultaneously by a Master server (20) and a Back-up server (22). The client is not aware of the redundancy. The system may be operating with either of the two servers being designated as the Master or the Back-up server.

While the manner of operation of HOTSWAP is described in the context of a single Master server and a single Back-up server, it will be understood by persons skilled in the art that the present invention may be adapted to support multiple Master server with multiple Back-up servers.

HOTSWAP operates on both the Master and the Back-up servers. The same server application program also runs on the Master and the Back-up. Both the Master and the Back-up servers receive the same input from the network. The Master and Back-up server applications programs will be able to maintain the same Application State if they receive the same sequence of inputs from the client commencing at the time of server start-up.

Both Master and Back-up servers receive the same input from the client. The Back-up sends its output to the Master. The Master receives and verifies the Back-up's output and forwards it on to the client. The Back-up produces the same output as the Master so that the Back-up is able to replace the Master at any time without the client's intervention or knowledge.

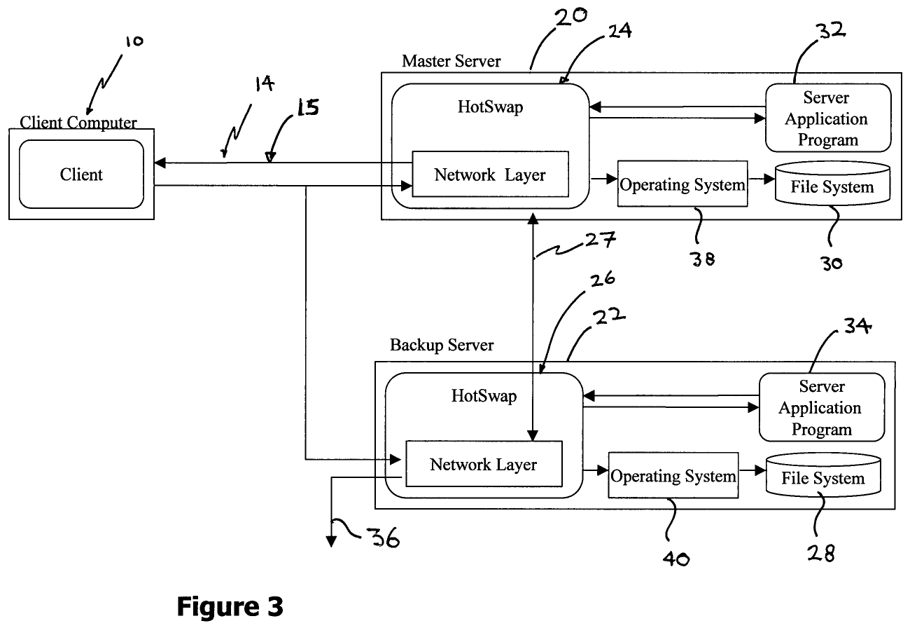

FIG. 3 shows a detailed view of the present invention controlling a Master (20) and Backup server (22) and their connection (14) to a client (10). The two independent servers (20) and (22) that share network connection (14) are configured to run identical HOTSWAP programs (24) and (26). One computer, shown here as (20) will become the Master and one shown here as (22) becomes the Backup. Each computer starts its own copy of the HOTSWAP program. The two HOTSWAP programs establish a connection (27) with each other. HOTSWAP negotiates the roles of Master (20) and Backup (22), and the unique network address they will share. The Backup synchronizes its file system (28) with the Master's file system (30). Master server and Backup server start their own server application programs (32) and (34) respectively and begin accepting network connections (14) from the client (10).

Client (10) establishes a connection to the Master and the Backup servers using their identical shared network address. The Master and Backup HOTSWAP programs (24) and (26) respectively accept the new connection and forward the connection to their local server application programs (32) and (34). Both copies of the server application program process the client's requests but only the Master's output (15) is sent to the client. The Backup HOTSWAP program (26) discards its output (36) as long as it observes the Master producing the same output as the Back-up. The Master and Backup HOTSWAP programs maintain their connection (27) with each other. If one detects an internal error, such as failure to respond to a client request or if their output disagrees or if a System Call fails on one computer but succeeds on the other then it will invoke fail over. Fail over is when the faulty server terminates and the other non-faulty server continues. The surviving server becomes the Master (if it wasn't already) and continues processing client requests.

Each HOTSWAP program monitors its respective server and the network traffic between that sever and its clients to ensure both Master and Backup servers are receiving the same input from the client and producing the same output. HOTSWAP maintains server synchronization by controlling the inputs to its respective server. If two servers start in the same initial state and receive the same input, they should produce the same output. HOTSWAP controls the inputs to is respective server by controlling that server's System Calls and the Network Connection State. Transparent fault protection requires synchronizing both Network Connection State and Application State between Master and Back-up. Synchronizing state between two running applications is difficult. The overhead of communication between the Master and Backup programs can be prohibitive by degrading the performance of the application so much that it is not usable. HOTSWAP takes the novel approach of synchronizing only the initial state of the application server programs and inputs to independent servers. This approach uses less communications overhead. HOTSWAP requires that if both the Master and Back-up receive the same input, they will produce the same output. The process of controlling the input of Master and Backup servers is referred to as synchronizing their Application State.

To synchronize Application State, the Master records its output and then verifies that the Back-up produces the same output. HOTSWAP assumes that if the Master and Back-up receive the same client input, and have been started in the same initial state, they will naturally maintain the same Application State and produce the same output.

However, the Master may receive input from non-deterministic outside events. For example:

All programs run under multitasking operating systems which rely on hardware interrupts to schedule tasks. The order and duration each task gets the processor is not deterministic;

The operating system may deliver asynchronous signals to a process at different points in execution. Two programs will not receive the same signal at the same stage of processing;

Different scheduling and event handling can cause the operating system to process network traffic in different order. In particular;

New connections may be accepted in any order;

Packets may be lost at one host but not on another;

Outgoing packets will be assembled in different sized chunks due to buffering, timing, and retries;

The clocks on two hosts can never be completely synchronized, and scheduling will never guarantee that two programs read the clock at the same moment;

Operating systems supply arbitrary ids for system objects. For example, process IDs returned by fork( ), wait( ), and getpid( ). The Master and Back-up processes will have different process ids;

Programs may access hardware-specific files such as:

/dev/urandom the system hardware random device;

/proc/*—a Linux file system which represents the kernel's view of processes by process ID;

Some programs may depend on uninitialized memory for input (intentionally or not).

Many of these sources of nondeterminism come from the operating system (38) and (40) itself through system calls like time( ), fork( ), getpids( ), read( ), etc. HOTSWAP reduces nondeterminism by synchronizing network traffic and system calls.

Encrypted network connections provide an example of the problem of replicating non-deterministic system calls to synchronize Application State. When the client connects, the Master server computes a random encryption key by using pseudo-random inputs like the current time, the server's process ID, and possibly a hardware random number generator. If any of these inputs are different, the Backup server will compute a different encryption key and fail to establish the same connection to the client. HOTSWAP captures and replicates system calls to get the current time, process ID, and random number devices so the Backup will have the same inputs to its random key generator as the Master, and thus both will computer the same encryption key.

Synchronizing the Application State

HOTSWAP overcomes inherent non-determinism by ensuring that the files systems of the Master and Back-up are identical before starting the servers. Non-deterministic System Calls are intercepted by HOTSWAP and synchronized on the Master and the Back-up. This ensures that the Master and the Back-up receive the same results from otherwise non-deterministic System Calls and thus maintains the same Application State on both servers.

Synchronizing the initial states of the Master and Back is accomplished by ensuring that the Master and Back-up are relying upon the same executables, configuration files, and data files. This is be done by copying files from the Master to the Back-up before starting the servers. When the Application State of the Master and Back-up are synchronized, they will act in an identical manner and reproduce writes to local files and maintain exact duplicates of data files. In this manner, the Back-up operating system (40) is able to maintain synchronicity with the Master operating system (38) without using such devices as a shared file server or similar back-up strategies.

The System Call is a function call that is processed ultimately by the operating system program. For example, on an UNIX based system programmed using C, all System Calls are made available by “libc.so”, the shared system library. Different operating systems provide different mechanisms for implementing system calls. System Calls may be intercepted so that one program can divert the course of a system call before it gets into the operating system. There are several techniques for intercepting system calls depending on the operating system. For example, system calls may be intercepted within the operating system, just before they get to the operating system, before they get to libc, or just before the application invokes the system call.

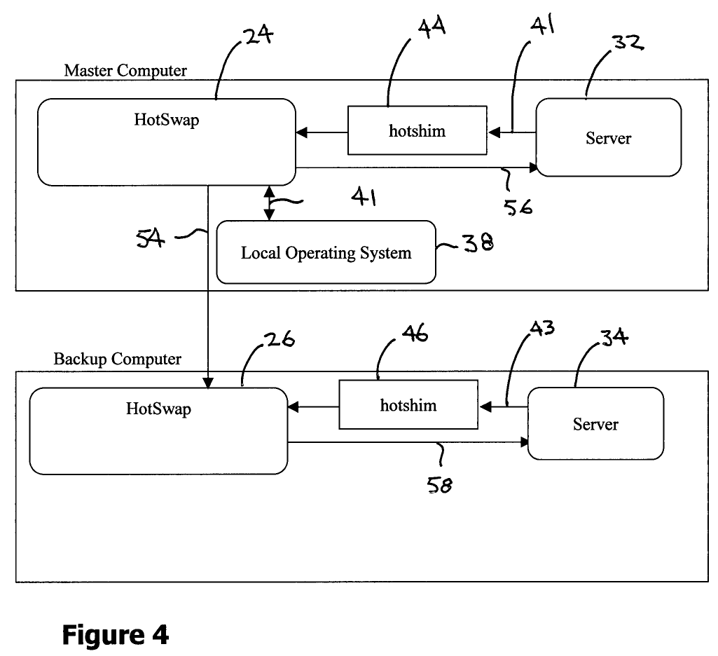

FIG. 4 shows the details of how HOTSWAP synchronizes a server's application state by capturing local system calls. Server application programs (32) and (34) gain input from the local system by executing system calls (41) and (43) to open and read files, get the current date, etc. When a server invokes a local system call, HOTSWAP's synchronization library HOTSHIM (44) and (46) catches the call and ensures the Master and Backup server application programs receive the same result.

The Master HOTSWAP (24) invokes the system call (50) on its local operating system (52) and sends (54) the result to HOTSWAP (25) on the Backup. The Backup waits for the Master's result. Both Master and Backup servers receive the Master's result and send it (56) and (58) to their respective server application programs (32) and (34)

If a system call fails on the Master but succeeds on the Backup, the Backup may invoke fail over.

The method for intercepting system calls depends on the specific mechanism that the operating system uses for implementing system calls. The present invention may use any appropriate mechanism for intercepting system calls. Current techniques for intercepting system calls are: (a) inserting a library between the server and system libraries, (b) redirecting function calls within the running server, or (c) modifying the system itself.

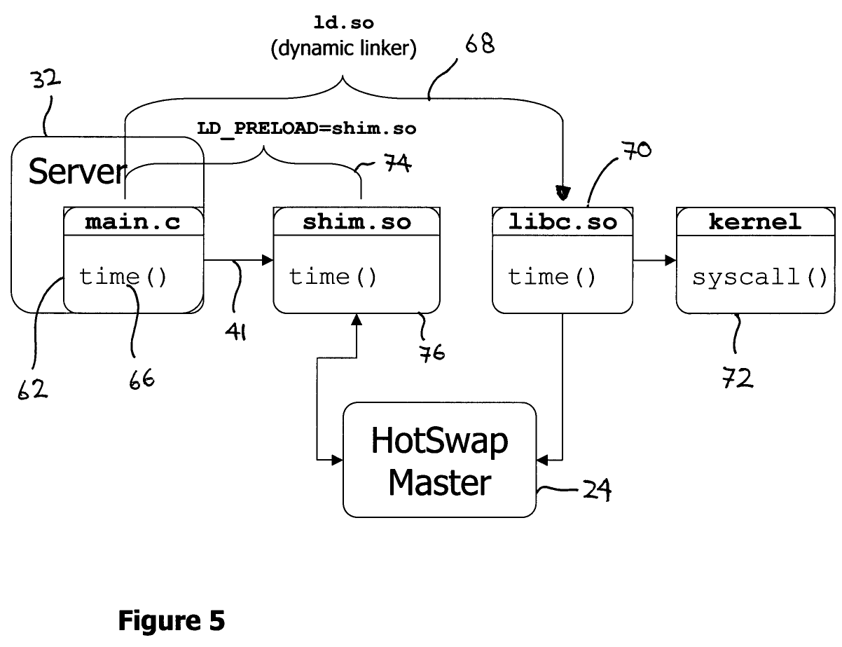

The synchronization of System Calls can be affected by a variety means such as modifying the operating system call entry point, utilizing external debugger, dynamic code patching, and LD_PRELOAD. HOTSWAP uses LD_PRELOAD in a LINUX operating system as shown in FIG. 5.

FIG. 5 shows the details of how HOTSWAP (24) on the Master server uses LD_PRELOAD to achieve system call capture on the Linux operating system. A server application program (32) consists of code modules (62) which make system calls (41), such as the time( ) function (66). The Linux operating system provides a dynamic linker (68) that connects the system call from the server application program (32) to the system library (70). The system library (70) passes the call to the operating system (72) also known as the kernel. The Linux dynamic linker (68) provides a mechanism known as LD_PRELOAD (74) which allows the insertion of a “shim” library (76) between the server module (32) and the system library (70). HOTSWAP commands the LD_PRELOAD mechanism to intercept system calls for running servers before they get to the system library. Once the System Call is intercepted the Master and Back-up exchange the System Call information as shown in FIG. 4.

Synchronizing the Network Connection State

A master computer may fail while clients are actively connected to its server application program. Transparent fail over requires that the backup computer must continue the client connection without interruption. Other systems for fault tolerance have limited ability to continue client connections on failover. Continuing client connections requires synchronizing the state of the conversation between client and server as well as synchronizing the state of its network connection. HOTSWAP's ability to preserve network connections makes it suitable for both transaction-oriented and continuous connections. This is one advantage of the present invention.

A client establishes a network connection to a server by executing network system calls to the client's operating system. The client's and server's operating systems provide a network layer which encapsulates their conversation within a network protocol. A network protocol breaks a conversation into a sequence of network packets, which are routed and reassembled. The network protocol uses state variables in each packet to reassemble packets into the original conversation. The network layers within the client and server operating systems negotiate the state of the network protocol when the connection is established. HOTSWAP intercepts network traffic and provides a simulated network layer outside the host operating system to ensure the network protocol state is synchronized between Master and Backup.

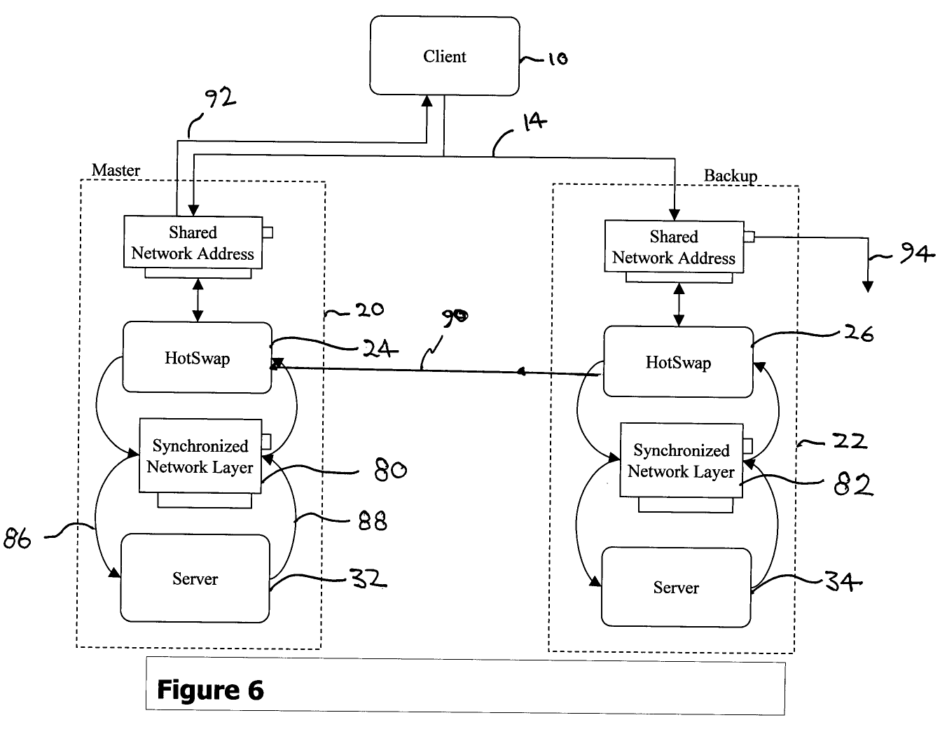

FIG. 6 shows how the present invention intercepts network traffic. The client (10) sends network traffic (14) addressed to the address shared by the Master (20) and Back-up server (22). Each HOTSWAP program (24) and (26) provides a simulated network layer (80) and (82) to its respective server program (32) and (34). The Master server (20) receives input (86) from the client and produces output (88) for the client in reply. The Backup HOTSWAP (26) sends a checksum (90) of its output to the Master. When the Master verifies the Back-up's checksum the Master sends its output to the client (92). When the client acknowledges the Master's output the Back-up discards its own output (94). If the output checksum (90) does not agree, the Back-up server terminates its operation. If the Master fails to produce output, the Back-up invokes failover.

When the Back-up invokes failover, it sends all pending output to the client and continues processing without synchronizing with the (presumably dead) Master. If the Master recovers, it will see that the Back-up has continued processing ahead of it, and will terminate itself.

HOTSWAP uses the process above to ensure Backup and Master servers produce the same output for a client. HOTSWAP must also ensure the connection state between the Master and Backup is preserved so the Backup can continue the connection if the Master fails. HOTSWAP synchronizes client server connections that use the TCP protocol. Other embodiments of the present invention may synchronize other protocols.

TCP provides a reliable two-way stream of data between client and server. The TCP protocol divides a sequence of bytes into packets, reassembles packets in order, and retransmits packets that get lost. Each TCP packet contains flags for initializing (SYN) and terminating (FIN) the connection, a sequence number (SEQ) for ordering bytes, an acknowledgement (ACK) of the latest sequence number received, and a windows advertisement (WIN) of the number of bytes the receiver is willing to accept.

A client initiates a connection to a server by sending a packet to that server's unique network address. The client's TCP chooses an initial SEQ number to the packet and sets its SYN flag to note the beginning of the connection. The packet is routed through a series of internet gateways to the gateway of the destination server. The destination server's gateway does an ARP request to discover the MAC address of the destination server. The destination server receives the packet from the client and replies with an ACK number to acknowledge the client's SEQ. The server accepts the new connection. Throughout a TCP connection, the client and server exchange packets with SEQ and ACK numbers to acknowledge which packets that have been received and which need to be retransmitted. The connection terminates when both sides send FIN packets.

These are the features of TCP related to the preferred embodiment of the invention:

The initial sequence numbers SEQs are randomly chosen by the master and backup independently, but they must be consistent for the client.

The master and backup servers will break a sequence of data into different sized packets at different rates.

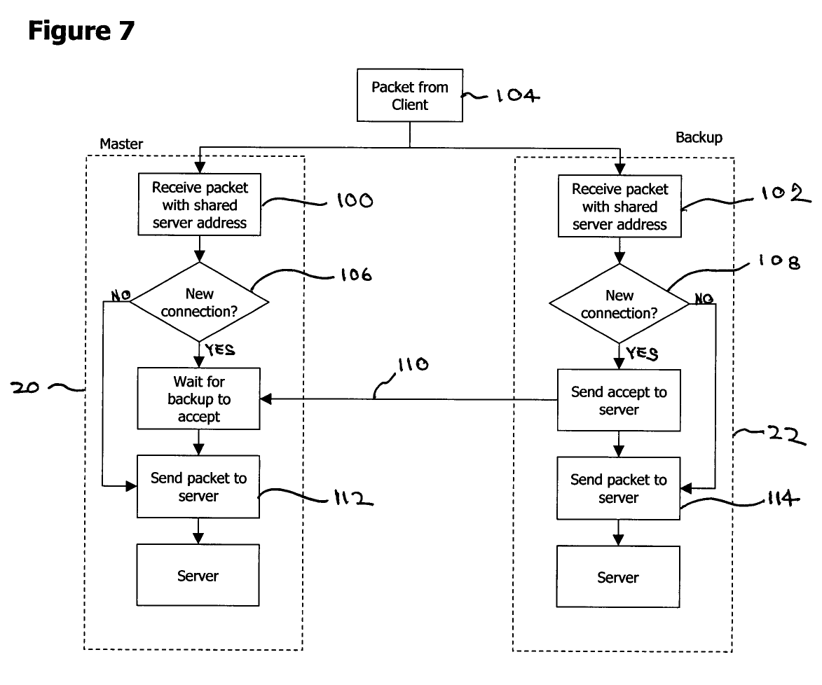

FIG. 7 shows how HOTSWAP processes network packets from client to server. The Master and Backup network layers are first configured to use a common IP and MAC address (100) and (102). If it is a new connection (106) and (108) then the Master queues the packet. When the Backup (22) receives the first packet of a connection from the client (104), it informs the master (110). When both Master and Backup have accepted the first packet of a connection, they allow their servers to accept the connection (112) and (114). This ensures both Backup and Master servers will accept connections in the same order.

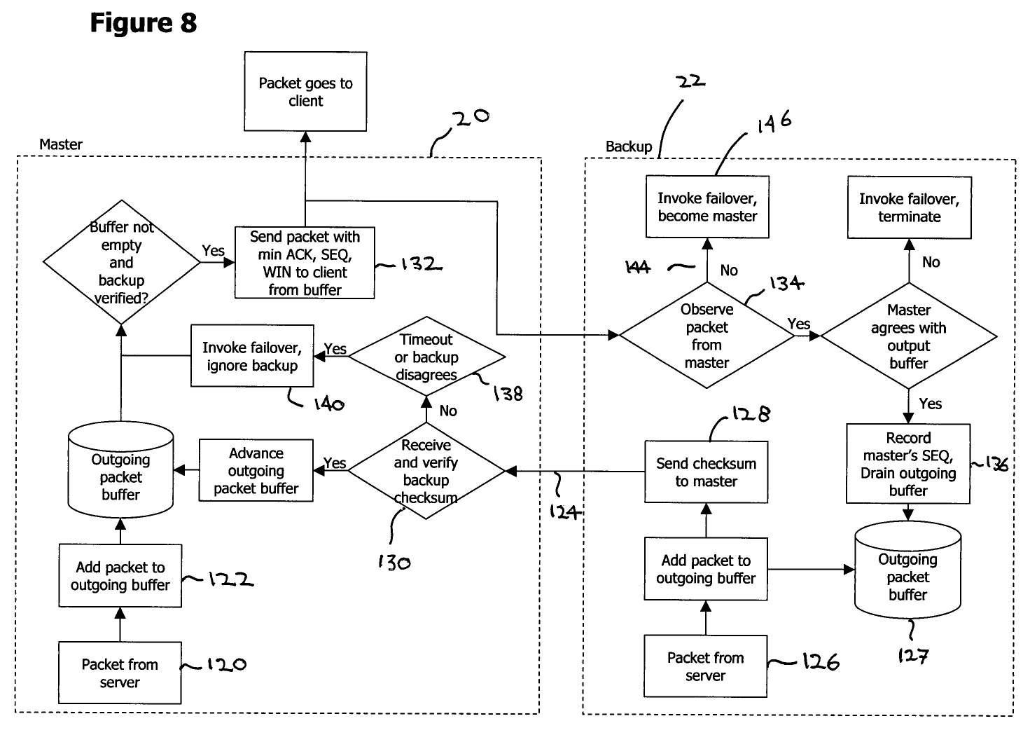

FIG. 8 shows how HOTSWAP processes network packets from server to client. When the Master (20) server produces output for the client (120), the master HOTSWAP buffers the output (122) and waits for the Backup (124). When the Backup server produces output (126), its HOTSWAP buffers its output (127) and sends (124) a small checksum (128) of its output to the Master (20). If the checksums of the Master and Backup output agree (130), the output is assumed to be the same. The Master must be careful not to acknowledge packets that it received from the client but that the Backup has failed to receive, or to advertise a window that the Backup cannot accept. The Master sends the least amount of buffered data that has been acknowledged by both Master and Backup (132). The Backup observes (134) the Master's packet sent to the client. The Backup records the master's SEQ to use later if the Backup invokes failover. The Backup drains its output buffer (136) when the client acknowledges the output sent by the Master.

If the Master and Backup both produce output, but they disagree (138), the Master invokes fail over (140) and the Backup terminates. If the Backup produces output, but the Master fails to produce output (144) within a timeout period, the Backup invokes fail over (146) and becomes the new Master.

This method allows the Backup to take over from the Master at any time in communication without disrupting the TCP connection state between server and client. This method also verifies that the Master and Backup versions of a program are producing the same output for a client's requests.

The following is a sample transcript of what happens when HOTSWAP is running:

1. The user boots the Master and Back-up servers

| | |
|---|---|
| User | synchronize file system with rsync |
| User | set duplicate IP and MAC addresses for tap |
| | devices on Master and Back-up |
| | machines |
| User | run hotswap tap0 server arg0 arg1 ... argn |
| | on Master server |
| User | run hotswap tap0 -b tap0 <Master |
| | server IP> on Back-up server |

2. Master and Back-up each run their own copy of the server application software and synchronize System Calls

| | |
|---|---|
| Master | wait for connection from Back-up |
| Back-up | connect to Master |
| Master | send argv and envp to client |
| Back-up, Master | set LD_PRELOAD = shim.so, |
| | exec(argv, envp) |
| Master Server | catch system call like time( ). |
| | The shim sends the result to the Back-up |
| Back-up Server | catch system call, e.g., time( ). |
| | Wait for time( ) result from Master and |
| | return that instead |

3. Master and Back-up accept connection from a client and verify output

| | |
|---|---|
| Client | sends SYN to IP |
| Master | drop SYN on tap, send SYN address to Back-up |
| Back-up | receive SYN, wait for Master, drop SYN on tap. |
| Master Server | accept socket, fork( ) returns |
| | the new Master pid to Back-up |
| Back-up Server | accept socket, wait for Master pid, then fork( ). |
| Master and | □write( ) to socket |
| Back-up Servers | |
| Master | read TCP packet from tap, wait for Back-up |
| Back-up | read TCP packet from tap, send it to Master |
| Master | compare TCP packet contents, send |
| | the smallest one |
| Client | Send ACK |
| Master and Back-up | drop client packet on tap. |

After a failure of the Master, Back-up is able to synchronize files without interrupting the service to the client. The user can later choose when to restart the Master and the new Back-up to achieve full fault tolerance again.

### ALTERNATE EMBODIMENTS OF THE INVENTION

Another embodiment of the present invention replicates just the changes to the file system such as write( )s) on a remote host without duplicating the whole running server. This effective for disaster recovery as it allows for dynamically updating the file system of a host far away.

Another embodiment of the present invention is for use with are not-quite independent hosts. There may be contexts where servers run on connected hardware but duplicating input is still the most efficient way to replicate state between the servers. This may be used on fault-tolerant multi-processor machines.

Another embodiment of the present invention allows for server modification wherein the server is rewritten to access the present invention's functions directly to improve performance.

While the invention has been described in conjunction with a specific best mode, it is to be understood that many alternatives, modifications, and variations will be apparent to those skilled in the art. Accordingly, it is intended to embrace all such alternatives, modifications and variations which fall within the spirit and scope of the claims. All matters set forth herein or shown in the accompanying drawings are to be interpreted in an illustrative and non-limiting sense.

What is claimed is:

1. An apparatus for providing transparent fault tolerance within an application server environment comprising a network of computers, said apparatus comprising:
a. a first server designated as a master server for storing and operating a first operating system program communicating by system calls with a first server application program and a first fail over protection program, said first server designated as a master server connected to a computer network and having a network address; said first server having a first initial state, a first application state and a first network connection state;
b. a second server designated as a back-up server for storing and operating a second operating system program communicating by system calls with a second server application program and a second fail over protection program; said second operating system program, said second server application program and said second fail over protection program identical respectively to said first operating system program, said first server application program and said first fail over protection program; said second server designated as a back-up server connected to said computer network; said second server having a second initial state, a second application state and a second network connection state
c. wherein the first server designated as a master server is operatively connected to the second server designated as a back-up server and wherein the first server is in continuous communication with said second server so that the first fail over protection program is in constant communication with the second fail over protection program and further wherein the operation of the first server and second server are synchronized by the first and second fail over protection programs respectively;
d. wherein the first and second fail over protection programs include:
i. means for establishing synchronicity between the first server and the second server;
ii. means for monitoring synchronicity between the first server and the second server;
iii. means for detecting non-synchronicity between the first server and the second server; and,
iv. means for invoking the first or second fail over protection programs upon detection of non-synchronicity between the first and second servers;
e. wherein said first and second fail over protection programs, when invoked, cause a transfer of server operations from a failed server to a non-failed server upon the detection of non-synchronicity or non-responsiveness of either server, and wherein transfer from failed to non-failed server is totally transparent to the client.

2. The apparatus as claimed in claim 1, wherein means for establishing synchronicity between the first server and the second server includes means for:
a. synchronizing the first and second initial state;
b. synchronizing the first and second application state; and,
c. synchronizing the first and second network connection state.

3. The apparatus as claimed in claim 2 wherein means for synchronizing the first and second application states includes means for intercepting system calls between the first server application program and the first operating program.

4. A method for providing transparent fault tolerance within an application server environment comprising a network of computers, said method comprising the steps of:
a. providing a first server for storing and operating a first operating system program, a first server application program and a first fail over protection program;
b. providing a second server for storing and operating a second operating system program, a second server application program and a second fail over protection program;
c. placing said first server in continuous communication with said second server;
d. designating from the first server and the second server a master server and a back-up server;
e. synchronizing the operation of the master server and the back-up server;
f. providing from the network an identical client data stream input simultaneously to the master server and the back-up server wherein:
i. the master server and back-up server have the same network address
ii. the master server and back-up server simultaneously process said identical client data stream; and wherein,
iii. the master server and the back-up server simultaneously produce a respective first and second output data streams; and wherein,
iv. said first and said second output data streams are identical if the master server and the back-up server are operating correctly;
g. comparing by said first and second fail over protection programs respectively, said first output data stream with said second output data stream for divergence from identicality of the first output data stream from the second output data stream;
h. detecting by said first and second fail over protection programs no divergence from identicality of the first output data stream from the second output data stream;

5. The method of claim 4 including the steps of:
a. receiving by said first or second fail over protection programs an indication of divergence from identicality of the first output data stream from the second output data stream;
b. invoking the first or second fail over protection program wherein the backup server assumes the duty of the master server without breaking any network connections.

6. The method as claimed in claim 5, wherein the first and second operating system programs and the first and second server application programs are deterministic so that when the first and second operating system programs and the first and second server application programs receive the same input they will produce the same output.

7. The method as claimed in claim 6 wherein the step of synchronizing the first master and second back-up servers comprises the steps of:
a. providing to each of the master and back-up operating system programs identical executables, configuration files and data files prior to starting the master and back-up operating system programs;
b. synchronizing the operation of the master application server program with the back-up application server program so that the master and back-up application server programs have an identical internal operating state and so that each of the master and back-up application server programs produce an identical first and second data output respectively; and,
c. synchronizing the network connection state between the master server and back-up server application programs and the network.

8. The method as claimed in claim 7, wherein synchronization of the master and back-up server application programs comprises the steps of:
a. providing the master server and the back-up server with identical interfaces to the network;
b. providing in each of the master and back-up servers a system call interceptor which will intercept system calls traveling from their respective server application systems to their respective operating system programs;
c. starting the master and the back-up server application programs; and,
d. synchronizing the result of system calls between master and backup.

9. The method as claimed in claim 8, wherein synchronizing the network connection state between the network and the master and back-up server application programs comprises the following steps:
a. providing identical network addresses to the master and back-up servers;
b. providing a simulated network layer within the master server and back-up servers;
c. providing a client data stream to each of the master server and back-up server;
d. receiving said client data stream by the master server simulated network layer;
e. transmitting the client data stream received by the master server simulated network layer to the master server application program;
f. processing the client data stream by the master server application program;
g. detecting differences in the master and backup's output; and,
h. invoking the first fail over protection program.
